(19) United States
(12) Patent Application Publication
(10) Pub. No.: US 2007/0100729 A1
(43) Pub. Date: May 3, 2007

(54) Systems and methods for making conditional sales of investments

(75) Inventor: Perry Chen, Brooklyn, NY (US)

Correspondence Address: Daniel H. Golub, 1701 Market Street, Philadelphia, PA, 19103, US

(73) Assignee: Kickstartr, LLC, Brooklyn, NY (US)

(21) Appl. No.: 11/634,702

(22) Filed: Dec. 6, 2006

Related U.S. Application Data
(63) Continuation-in-part of application No. 11/501,427, filed on Aug. 9, 2006.
Application No. 11/501,427 is a continuation-in-part of application No. 10/946,521, filed on Sep. 20, 2004.
(60) Provisional application No. 60/577,280, filed on Jun. 4, 2004.

(51) Int. Cl. G06Q 40/00

(52) U.S. Cl. 705/36 R

(57) ABSTRACT

Methods and systems for raising capital through the conditional sale of investments online, wherein each investment provides an owner with a financial interest in an entity that (i) produces, develops, provides or has a financial interest in a specified good, service, event, achievement, or venture; or (ii) commits to produce, develop, provide or gain a financial interest in said good, service, event, achievement, or venture.

### CROSS-REFERENCE TO RELATED APPLICATIONS

The present application is a continuation-in-part of U.S. patent application Ser. No. 11/501,427, filed Aug. 9, 2006, entitled “Systems and Methods for Making Conditional Purchase Requests,” which is a continuation-in-part of U.S. patent application Ser. No. 10/946,521, filed Sep. 20, 2004, entitled “Method and System for Making a Conditional Event Binding on Purchasers and Vendors,” which claims the benefit of U.S. Provisional Patent Application No. 60/577,280, filed Jun. 4, 2004. The content of these earlier applications is incorporated herein by reference.

### FIELD OF THE INVENTION

The present invention relates to methods and systems for raising capital for a project through the conditional sale of investment items online.

### BACKGROUND OF THE INVENTION

Traditionally, the production of an event can require significant expense and risk. An event, such as a concert, requires the vendor, usually the event promoter, to coordinate venues, talent, promotions, advertising and other related event planning services. Usually, the vendor incurs significant expense in covering this overhead and accepts an amount of risk in return for the potential profit from the event. It is not uncommon for events to fail to generate revenue sufficient to cover the expenses and compensate for the work and financial risk of the vendor. Sometimes, in anticipation of insufficient revenue, vendors will choose to “cut their losses” by canceling an event and refunding the event purchase price to ticket holders. In either case, the outcome is unsatisfactory to the vendor.

Similarly, the performance of an achievement, such as designing a new product, requires the product development company to coordinate personnel, resources, market research and other research and development and related product services. Again, as in the case of the concert promoter, the company incurs significant risk and expense, and it is not uncommon for the new product to generate insufficient revenue or the development process to be terminated prematurely due to the anticipation of insufficient revenue.

Under this traditional system, many events and achievements are considered too risky or cumbersome to attempt. Inevitably, it is probable that a potentially successful event or achievement will not be attempted because of the risk inherent in this traditional system that the event or achievement will not be profitable.

Due to the emergence of the Internet, the traditional system of product purchasing and the market experience of vendors and buyers have vastly changed. The benefits of the Internet for vendors include the increase in the amount of available buyers, and the decrease of many traditional overhead expenses. In turn, potential buyers have access to more vendors and more products and are able to shop 24 hours a day. Additionally, the rise of e-commerce has brought with it many new and exciting ways for vendors and buyers to do business.

The use of the Internet has also been established to create efficiencies in relation to the billing and payment for the purchase of goods and services. The widespread use of credit and debit cards and other online credit and debit services has allowed remote online transactions to flourish with added speed and security. In many instances such transactions are instantaneous, as vendors communicate with the credit institutions over communications networks to verify a buyer's identity and credit worthiness, and to have a buyer's charges approved or rejected in relation to the purchase of products or services.

Another feature of credit card transactions commonly used is for the vendor to perform an “authorize only” transaction. In such a transaction the amount is not charged to the buyer at the time of authorization but rather the buyer's credit card company authorizes the future charge of a specific amount of funds. This authorization guarantees payment to the vendor from the credit card company if, and when, such a charge is submitted. This method is widely used by car rental companies and hotels as an alternative to requiring a cash deposit.

Thus, there is a need to supplement the traditional event and achievement production system with a dynamic system that minimizes vendor risk by providing that the sale of the event or achievement shall become binding on the buyer and the vendor only upon the satisfaction of some pre-defined criteria specified by the vendor. Such a system would utilize the benefits of “authorize-only” credit card transactions to ensure efficiency and guarantee payment to the vendor upon satisfaction of the pre-defined criteria. Such a system would also allow vendors to offer a broader variety of events and achievements to the public by creating an environment where events or achievements that were previously too risky or too cumbersome for a vendor to consider producing can now be offered at limited risk to the vendor.

“Behind-the-Scenes” content has been widely used to supplement or promote a main product (usually a film or television show) as a promotional tool, as included bonus material with a DVD or VHS purchase, or as additional products themselves for those with extended interest in a television show or film.

Thus, in many cases, it is commercially beneficial to supplement the sale of an event or achievement with content related to production or development activities for the event or achievement. This content can serve to entertain and/or inform the buyer. In most cases this content can best be delivered over the internet or digital cable; or otherwise digitally delivered.

Frequently, the development and production of an event or achievement takes a significant amount of time. Feature-length films and music albums can take months or years to be developed, produced, and prepared for digital or physical delivery. Any extended waiting period between the purchase and delivery of product can serve as a deterrent to potential buyers. Thus, buyers may hesitate to purchase events or achievements that will not be delivered in the immediate future.

Thus, in many cases, there is the need to supplement the sale of an event or achievement with content related to production or development activities for the event or achievement. This content can serve to entertain and/or inform the buyer, and also further provides a solution to the problem of buyers waiting extended dormant periods for the delivery of an event or achievement.

### SUMMARY OF THE INVENTION

The present disclosure extends the concepts disclosed in parent application Ser. Nos. 11/501,427 and 10/946,521 to the raising of capital for a “project” through the conditional sale of “investment items” online. A project is an endeavor by an entity or company for the purposes of producing, developing, providing or gaining a financial interest in a specified good, service, event, achievement or venture. Acquired for future financial return or benefit, investment items are investments in the form of financial instruments, such as securities or other cash instruments, or derivative instruments, that give the owner the rights to a financial interest in the success of a specified good, service, event, achievement or venture via a financial interest in an entity or company that (i) produces, develops, provides or has a financial interest in said good, service, event, achievement, or venture; or (ii) commits to produce, develop, provide or gain a financial interest in said good, service, event, achievement, or venture. The particular good, service, event, achievement or venture could be a concert series, a new film or album, or a new investment fund, amongst other things. The “entity or company” could be a new start-up company, a new record label, or an entity formed to share the profits from a new film, amongst other things.

In many cases, it is commercially beneficial to supplement the sale of investment items with “behind-the-scenes” content related to production or development activities of the project. This content can serve to entertain and/or inform the buyer. In most cases this content can best be delivered over the internet or digital cable; or otherwise digitally delivered.

In many cases, it is commercially beneficial to supplement the sale of investment items with a product (good or service) related the project. This product may be a DVD of the film that the investment items are used to fund, or a ticket to an event that the investment items are used to fund. This product may also be another item related to the project, such as a hat or t-shirt.

In accordance with one aspect, the present application is directed to a method and system for raising capital through the conditional sale of investments online, wherein each investment provides an owner with a financial interest in an entity that (i) produces, develops, provides or has a financial interest in a specified good, service, event, achievement, or venture; or (ii) commits to produce, develop, provide or gain a financial interest in said good, service, event, achievement, or venture. A network site accessible over a communication network from remote computers is provided. Pre-defined criteria are received from a seller of the investments. The pre-defined criteria must be satisfied before the seller or entity is obligated to produce or develop the good, service, event, achievement or venture. The pre-defined criteria include an aggregate threshold volume of conditional purchases of the investments that must be made by a plurality of different buyers.

Commercial terms relating to making a conditional purchase of an investment are displayed to the buyers over the network site. The commercial terms include one or more seller-defined prices associated with the conditional purchase.

In some embodiments, content related to the production or development activities for the good, service, event, achievement or venture is identified to the buyers over the network site. In these embodiments, an agreement is received from the entity to make the content available to each buyer in exchange for the conditional purchase of an investment during a time period following satisfaction of the pre-defined criteria and during the production or development activities (which commence, e.g., after satisfaction of the pre-defined criteria.)

In some embodiments, a product related to the good, service, event, achievement or venture is identified to the buyers over the network site. In these embodiments, an agreement is received from the entity to produce and deliver the product to each buyer in exchange for the conditional purchase of an investment during a time period following satisfaction of the pre-defined criteria.

Conditional purchase requests for investments are received from the plurality of buyers over the network site. Each of the conditional purchase requests includes credit or debit account information from a buyer and specifies a conditional purchase amount that includes at least one of the seller-defined prices. In response to each conditional purchase request, an authorize-only credit or debit transaction is executed using credit or debit account information from the buyer, wherein the authorize-only credit or debit transaction conditionally binds the buyer to make a purchase of an investment only upon the satisfaction of the pre-defined criteria.

Upon the satisfaction of the pre-defined criteria, a credit or debit account of each buyer that made one of said conditional purchase requests is automatically charged, and the seller or entity is obligated to produce or develop the good, service, event, achievement or venture. The conditional purchase amounts specified in the conditional purchase requests include seller-defined prices that are independent of an aggregate volume of conditional purchases made by the buyers.

In some embodiments, following satisfaction of the pre-defined criteria and during the production or development activities, the content is made available to each buyer that made one of the conditional purchase requests. In these embodiments, the pre-defined criteria represent criteria that must be satisfied before the seller or entity is obligated to cause (i) the good, service, event, achievement or venture, and (ii) the content, to be produced. In these embodiments, upon the satisfaction of the pre-defined criteria, the vendor is obligated to cause the project and the content to be produced.

In some embodiments, following satisfaction of the pre-defined criteria a related product is produced and delivered to each buyer that made one of the conditional purchase requests. In these embodiments, the pre-defined criteria represent criteria that must be satisfied before the seller or entity is obligated to cause (i) the good, service, event, achievement or venture to be produced, and (ii) the related product to be produced and delivered. In these embodiments, upon the satisfaction of the pre-defined criteria, the seller or entity is obligated to cause (i) the good, service, event, achievement or venture to be produced, and (ii) the related good or service to be produced and delivered.

Further embodiments include defining, by the seller, a period for a buyer to conditionally purchase an investment over the network site.

The pre-defined criteria may represent criteria that must be satisfied before the seller is obligated to cause the an event to be produced, and after the credit or debit account of a buyer is charged, the buyer is issued a ticket for the event associated with the project.

In some embodiments, after the credit or debit account of a buyer is charged, the buyer is issued a receipt confirming the purchase of an investment.

The seller may attempt to raise capital for a plurality of goods, services, events, achievements and/or ventures, wherein each good, service, event, achievement or venture has its own pre-defined criteria. In these embodiments, the seller becomes bound to produce only those goods, services, events, achievements and/or ventures projects that achieve their corresponding pre-defined criteria.

A secure area of the network site may be provided which includes a private account page accessible by a seller that has created an account with the network site. Within the secure area, the seller may view information updated to reflect the completion of a transaction. The seller may also view the status of the progress toward satisfaction of the pre-defined criteria with respect to at least one of the goods, services, events, achievements and/or ventures on the seller's private account page. In addition, the seller may create a listing of information for a new good, service, event, achievement and/or venture on a new page accessible by the seller from the seller's private account page.

In some embodiments, information concerning a future good, service, event, achievement and/or venture may be accessed using a public area of the network site, and a secure area of the network site is accessed for entering credit or debit account information in order to make a conditional purchase request. The credit or debit account information may be transmitted to a credit or debit account company over the network.

In some embodiments, the secure area of the website can optionally be used to permit the buyer to create an account page, and the completion of a purchase transaction is confirmed on the buyer's account page. Also, in such embodiments, the buyer may view the status of the progress toward satisfaction of the pre-defined criteria for an item of interest on the buyer's account page, but only to the extent permitted by the applicable seller. In embodiments where the buyer receives content after satisfaction of the pre-defined criteria, the buyer may receive the content online through an area of the network site associated with the content on the network site or through a cable, satellite, or other digital network.

In some embodiments, the production or development activities concern production or development of an artistic work, and the content corresponds to efforts of a creator of the artistic work to produce the artistic work. Alternatively, the production or development activities concern production or development of a non-fiction work, and the content corresponds to efforts of a creator of the non-fiction work to produce the non-fiction work. In other embodiments, the production or development activities concern production or development of an interactive video game, and the content corresponds to efforts of a creator of the video game to produce the video game. In still further embodiments, the production or development activities concern production or development of a comic book, and the content corresponds to efforts of a creator of the comic book to produce the comic book. In still further embodiments, the production or development activities may concern production or development of a new start up company, and in such cases, the content may correspond to efforts of the employees of the start-up company to be successful, and in such cases, the content may correspond to “behind-the-scenes” footage of the company's operations. In still further embodiments, the production or development activities may concern production or development of a new record label, and in such cases, the content may correspond to “behind-the-scenes” footage of the labels' artists on tour and/or producing albums and/or shooting music videos.

In accordance with a further aspect, the present invention is directed to a system and method for raising capital through the conditional sale of investments online wherein each investment provides an owner with a financial interest in an entity that (i) produces, develops, provides or has a financial interest in a specified good, service, event, achievement, or venture; or (ii) commits to produce, develop, provide or gain a financial interest in said good, service, event, achievement, or venture. A network site accessible over a communication network from remote computers is provided. Pre-defined criteria are received from a seller of the investments. The pre-defined criteria must be satisfied before the seller or entity is obligated to produce or develop the good, service, event, achievement or venture. The pre-defined criteria include an aggregate threshold volume of conditional purchases that must be made by a plurality of different buyers for the investments. In this embodiment, the seller or entity has an option to agree to cause the good, service, event, achievement or venture to be produced or developed even though the pre-defined criteria have not been satisfied.

Commercial terms relating to making a conditional purchase are displayed to the buyers over the network site. The commercial terms include one or more seller-defined prices associated with the conditional purchase. In some embodiments, content related to the project is identified to the buyers over the network site. In these embodiments, an agreement is received from the seller or entity to make the content available to each buyer in exchange for the conditional purchase during a time period following satisfaction of the pre-defined criteria and during the production or development activities.

In some embodiments a product related to the good, service, event, achievement or venture is identified to the buyers over the network site. In these embodiments, an agreement is received from the entity or seller to produce and deliver the product to each buyer in exchange for the conditional purchase during a time period following satisfaction of the pre-defined criteria.

Conditional purchase requests for investments are received from the plurality of buyers over the network site. Each of the conditional purchase requests includes credit or debit account information from a buyer and specifies a conditional purchase amount that includes at least one of the seller-defined prices. In response to each conditional purchase request, an authorize-only credit or debit transaction is executed using credit or debit account information from the buyer, wherein the authorize-only credit or debit transaction conditionally binds the buyer to make a purchase of the investment item only upon the satisfaction of the pre-defined criteria or upon the seller or entity exercising the option.

Upon the seller or entity exercising the option to cause the good, service, event, achievement or venture to be developed or produced even though the pre-defined criteria have not been satisfied, a credit or debit account of each buyer that made one of said conditional purchase requests is automatically charged, and the seller or entity is obligated to cause the good, service, event, achievement or venture to be developed or produced. The conditional purchase amounts specified in the conditional purchase requests include seller-defined prices that are independent of an aggregate volume of conditional purchase made by the buyers.

In some embodiments, following satisfaction of the pre-defined criteria or exercise of the option, and during the production or development activities, the content is made available to each buyer that made one of the conditional purchase requests. In some embodiments, following satisfaction of the pre-defined criteria or exercise of the option, a product is produced and delivered to each buyer that made one of the conditional purchase requests.

In accordance with a still further aspect, the present invention is directed to a method for raising capital for a plurality of linked projects through the sale of investments online, wherein each investment provides the owner with a financial interest in an entity that (i) produces, develops, provides or has a financial interest in a specified good, service, event, achievement, or venture; or (ii) commits to produce, develop, provide or gain a financial interest in said good, service, event, achievement, or venture. A network site accessible over a communication network from remote computers is provided. Pre-defined criteria are received from a seller of investments. The pre-defined criteria must be satisfied before the seller or entity is obligated to cause a subset of a plurality of linked goods, services, events, achievements and/or ventures to be produced. The pre-defined criteria specify buyer demand parameters that determine which, if any, of the subset of the plurality of linked goods, services, events, achievements and/or ventures that the seller or entity is obligated to cause to be produced. The subset includes less than all of the plurality of linked goods, services, events, achievements and/or ventures.

Commercial terms relating to making a conditional purchase for one of the investments are displayed to the buyers over the network site.

In some embodiments, content related to the linked goods, services, events, achievements and/or ventures is identified to the buyers over the network site. In these embodiments, an agreement is received from the seller or entity to make the content related to their purchase available to buyers in exchange for the conditional purchase of an investment during a time period following satisfaction of the pre-defined criteria and during the production or development activities (which commence, e.g., after satisfaction of the pre-defined criteria.)

In some embodiments, a product related to the linked goods, services, events, achievements and/or ventures is identified to the buyers over the network site. In these embodiments, an agreement is received from the seller or entity to produce and deliver the product related to their purchase available to buyers in exchange for the conditional purchase of an investment during a time period following satisfaction of the pre-defined criteria.

Conditional purchase requests for each of the investments are received from the plurality of buyers over the network site. Each of said conditional purchase requests is associated with one of the linked goods, services, events, achievements and/or ventures, includes credit or debit account information from a buyer and specifies a conditional purchase amount. In response to each conditional purchase request, an authorize-only credit or debit transaction is executed using credit or debit account information from the buyer. The authorize-only credit or debit transaction conditionally binds the buyer to make a purchase for one of the investments only upon the satisfaction of the pre-defined criteria for the linked goods, services, events, achievements and/or ventures associated with the conditional purchase of the buyer.

Upon the satisfaction of the pre-defined criteria associated with each linked project in the subset, a credit or debit account of each buyer that made one of the conditional purchase requests associated with each linked good, service, event, achievement and/or venture in the subset is automatically charged, and the seller or entity is obligated to cause each of the linked goods, services, events, achievements and/or ventures in the subset to be produced.

In some embodiments, following satisfaction of the pre-defined criteria associated with each linked good, service, event, achievement and/or venture in the subset, and during the production or development activities associated with each linked good, service, event, achievement and/or venture for which the pre-defined criteria were satisfied, content related to goods, services, events, achievements and/or ventures in the subset are made available to each buyer that made one of the conditional purchase requests associated with each linked good, service, event, achievement and/or venture for which the pre-defined criteria were satisfied.

In some embodiments, following satisfaction of the pre-defined criteria associated with each linked good, service, event, achievement and/or venture in the subset, a product related to one or more goods, services, events, achievements and/or ventures in the subset is produced and delivered to buyers that made one of the conditional purchase requests associated with a linked good, service, event, achievement and/or venture for which the pre-defined criteria were satisfied.

### BRIEF DESCRIPTION OF THE DRAWINGS

For a further understanding of the features and advantages of the present invention, reference should be made to the following Detailed Description taken in conjunction with the accompanying drawings wherein:

FIG. 1 is a block diagram of a website of the present invention.

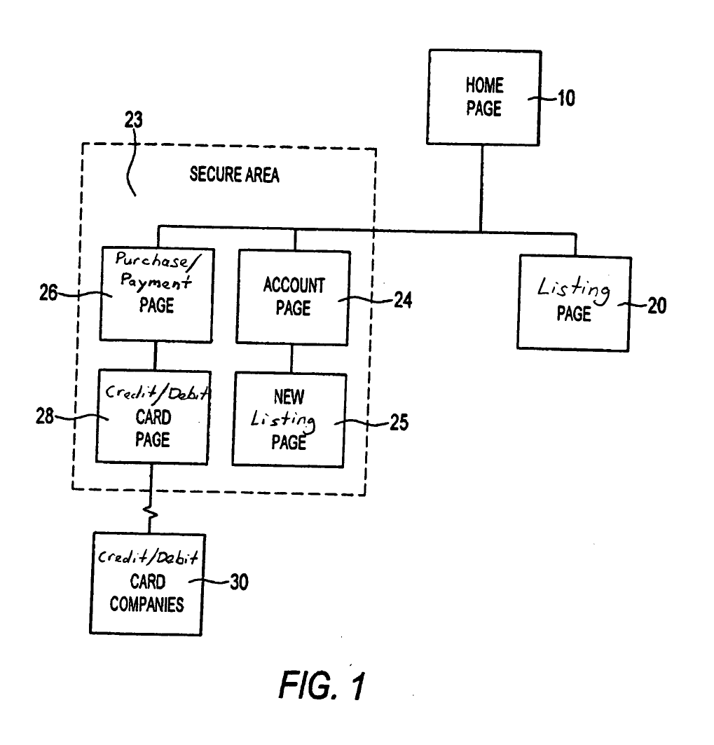

FIG. 2 is a block diagram showing the process of the present invention from the perspective of a buyer of an investment.

FIG. 3 is a block diagram showing the process of the present invention from the perspective of a seller of an investment.

### DETAILED DESCRIPTION OF THE PREFERRED EMBODIMENT

The website of the present invention is hosted on a server having a database for storing information relating to project listings. A project is an endeavor by an entity or company for the purposes of producing, developing, providing or gaining a financial interest in a specified good, service, event, achievement or venture (collectively, “Listings”). The website includes functionality for collecting purchase information or payment commitments received from buyers or participants as further described below. The website can be accessed by buyers, participants, sponsors and vendors over the Internet from remote terminals and computer systems.

The website has a public, unsecured, area and a secure area 23. Generally, the public, unsecured area includes posted information relating to Listings. The public unsecured area permits prospective buyers or participants to view the information relating to such Listings. The secure area 23 permits buyers, participants, sponsors or sellers to create private accounts and permits buyers or participants to enter their credit or debit card information and to make transactions. As can be further appreciated from the description set forth below, the website can be hosted by either the actual sponsor or seller associated with the Listings or through a third party intermediary that maintains a website for Listings on behalf of multiple sponsors or sellers.

The public area of the website consists of a home page 10. The home page is accessible by all prospective buyers, participants, sponsors and sellers visiting the website. The home page includes general information relating to the website and Listings. It also includes a log-in field for buyers, participants, sponsors and sellers to access their personal accounts. The home page also includes a search field that buyers may use to search Listings for investments according to specified criteria such as by the type of event, product, service, content, the name of the Listing, the name of the seller, product, artist, or sponsor, the location of the sponsor or seller. Such Listing may include investments for a concert, sporting event, stage event, charter travel or other event. Such Listings could also include investments associated with the introduction of a new product by a company such as “a film production company agreeing to produce a specific new film if $500,000 can be raised by Jan. 1, 2007 through conditional sales of investment items”. Such Listings could also include making content available to buyers such as “a video game company agreeing to design a new baseball video game, and provide content related to the production or development activities of the video game to buyers, if 100,000 shares of stock in an entity formed to share profits generated from the video game can be sold for $60 by Jan. 1, 2005”. Such Listings could also include producing and delivering a product to buyers such as “a band agreeing to record a new album, and produce and deliver a DVD of the album to buyers, if $10,000 can be raised by Jan. 1, 2007 through conditional sales of investment items”. Other examples of Listings are described below.

From the home page 10, a prospective buyer or participant may link to the webpage for a specified Listing 20 if the buyer or participant has particular interest in such Listing. The Listing page 20 displays a detailed explanation of the Listing. In cases where the Listing corresponds to an investment associated with an event, this page displays: (i) the scheduled date and time of the event and information relating to the pricing of the investment items; and (ii) commercial terms and conditions relating to the conditional sale of investment items including, if applicable, a description of the content relating to the production and development activities for the event that will be produced and made available to buyers, and including, if applicable, a description of the product related to the event, such as a ticket to the event that will be produced and delivered to buyers, and a statement of the pre-defined criteria set by the seller of the investments that must be achieved in order for the seller (or the entity that is the subject of the investments) to be obligated to produce or perform the event, and, if applicable, produce and deliver the content relating to the production and development activities of the event, and if applicable, produce and deliver a product related the event to buyers, such as a ticket to the event. Such pre-defined criteria include the pre-defined time period for the sales of the investment items to be conducted and may also include a specified level of total number of sales, a specified level of total sales income or other pre-defined conditions. In cases where the Listing corresponds to a investments associated with a new product, this page displays: (i) information relating to the pricing of the investment items, and (ii) commercial terms and conditions relating to the conditional sale of investment items including, if applicable, a description of the content relating to the production and development activities for the product that will be produced and made available to buyers, and including, if applicable, an agreement to produce and deliver the same or other product to buyers and a statement of the pre-defined criteria set by the seller of the investments that must be achieved in order for the seller (or the entity that is the subject of the investments) to be obligated to produce the new product, and, if applicable, produce and deliver the content relating to the production and development activities of the new product, and, if applicable produce and deliver the same or other product to buyers. Such pre-defined criteria include the pre-defined time period for the sales of the investment items to be conducted and may also include a specified level of total number of sales, a specified level of total sales income or other pre-defined conditions. Other commercial terms displayed on the Listing page 20 may include other information regarding the artist, company, or venue, if applicable. The investment item pricing structure information displayed on the Listing page 20 may include typical multi-tiered pricing related to select seating if the Listing corresponds to an investments associated with an event, or select media (DVD, Download, on Demand, etc.) if the Listing corresponds an investment associated with a film, and may display additional information relating to price discounts offered for certain purchases. The Listing page 20 may also permit a prospective buyer to view seating arrangements if the Listing corresponds to an investment associated with an event and any other information applicable to the Listing as desired by the seller.

From the home page 10, the buyer, participant, sponsor or seller may also access their account page 24. The account page 24 of each buyer, participant, sponsor or seller is located on the secure area of the website 23 and may be accessed by the buyer, participant, sponsor or seller only by entering their account identification and password. The account page 24 will be accessible by a buyer, participant, sponsor or seller only after the buyer, participant, sponsor or seller has created an account with the website.

Within the account page 24, the buyer, participant, sponsor or seller may view the feature referred to herein as the “status of satisfaction feature” of the present invention. This feature permits a buyer, participant, sponsor or seller to monitor the status of the pre-defined criteria relating to a Listing, to the extent permitted by the sponsor or seller. For example, if the pre-defined criteria relates to a total number of sales, the status of satisfaction feature will display information in either textual or graphical form showing the number of sales as of such date and time. Alternatively, if the pre-defined criteria relates to a level of total sales income generated by the Listing, the status of satisfaction feature will display the level of total sales income authorized by credit or debit card companies for buyers or participants as of such date and time. The information viewed over the status of satisfaction feature of the present invention is referred to as the “status of satisfaction information” herein.

A buyer or participant is able to view such status of satisfaction information to the extent permitted by the vendor or seller. Depending on the terms and conditions of the conditional sale or payment commitment, the seller or sponsor may restrict the information relating to a Listing displayed over the status of satisfaction feature by choosing various levels of transparency for the display of the status of satisfaction information to buyers or participants in relation to the Listing. For example, a vendor or seller may elect to have a completely blind conditional sale or payment commitment where buyers or participants are not permitted to monitor the satisfaction of the pre-defined criteria through the status of satisfaction feature. Alternatively, a vendor or seller may elect to have a partially or completely transparent sale or payment. In one embodiment of a partially transparent conditional sale or payment, the vendor or seller may allow buyers or participants to monitor status of satisfaction information that is only updated every 24 hours. In a fully transparent conditional sale or payment, buyers or participants would be able to monitor up-to-the-minute status of satisfaction information.

As an additional feature, a vendor or seller may elect to have certain status of satisfaction information displayed on the home page 10 or Listing page 20. For example, a vendor or seller may wish to display on the Listing page 20 the message “only 4 more investments need to be sold” for a particular conditional offer to become binding. A vendor or seller may elect to display different status of satisfaction information to buyers or participants through their account page 24 as compared to the status of satisfaction information made available over the home page 10 or Listing page 20 to the public.

In addition to status of satisfaction information, the account page 24 may also communicate other Listing or account related information to the buyer, participant, sponsor or the seller, as discussed below.

From a seller's or sponsor's account page 24, a seller or sponsor may access a new listing page 25 where the seller or sponsor may create a new Listing as desired by the seller or sponsor. As further described herein, the information submitted by the seller or sponsor over such new listing page 25 to create the new listing includes a description of the type of Listing, the pre-defined criteria including a pre-defined time period applicable to the Listing, other applicable terms and conditions, any pricing or payment structure for the Listing and any additional information relating to the Listing that the seller or sponsor desires to be included. If applicable, the new listing page 25 identifies any content that will be made available to buyers upon the satisfaction of the pre-defined criteria. If applicable, the new listing page 25 identifies any product that will be produced and delivered to buyers upon the satisfaction of the pre-defined criteria. After such information has been submitted, the seller or sponsor has the opportunity to review and correct such information. If such information is correct, the Listing will be included on a Listing 20 and accessible by prospective buyers and participants that access the website.

From the home page 10, a buyer or participant may access the Listing page 20 if the buyer or participant desires to get further information about a Listing. If the buyer or participant then wishes to make a purchase or payment with respect to the Listing, the buyer or participant will select the purchase/payment option link on the Listing page and will enter the purchase/payment page 26. In a case where a Listing corresponds to an investment associated with a concert, sporting or theatrical event, or similar event where the buyer will also receive tickets to the event, the purchase page 26 permits a prospective buyer to select tickets and other choices, if applicable. In a case where a Listing corresponds to an investment associated with a specific film, a specific album, or other project where the buyer will also receive a media copy of the project, the purchase page 26 permits a prospective buyer to select the type of media delivery or product, for example the specific film delivered on DVD or via download or by corresponding movie theater ticket or the specific album delivered on CD or via download, and other choices, if applicable.

Purchase/payment page 26 permits the buyer or participant to view the terms and conditions that shall apply to the conditional sale or payment commitment for the Listing. By making a conditional purchase or payment with respect to a Listing, the buyer or participant is agreeing to the displayed terms and conditions including having the purchase/payment amount authorized by its credit or debit card company utilizing an “authorize only” transaction. From the purchase/payment page 26, the buyer or participant may enter credit or debit card page 28 to initiate a transaction.

On the credit or debit card page 28, there is a prompt area that requires the buyer or participant to enter their credit or debit card and other information to be used to authorize the transaction.

The system of the present invention is interfaced with various credit or debit card companies 30. Once the buyer's or participant's credit or debit card information is entered, the system communicates with the credit or debit card company of the buyer/participant over a communication network to receive authorization for a future charge. The buyer's or participant's credit or debit card company must approve the authorization of future charges before the transaction will be approved by the system. This method of securing payment is in wide use in the credit or debit card industry. Although credit cards are the most common method of payment, one of ordinary skill in the art can appreciate that other mechanisms of payment may be used with the website including debit cards or other payment mechanisms that can guarantee future payment of pre-authorized transactions.

The credit or debit card company 30 processes the authorization request and transmits an “approved” or “declined” message to the website. The system then immediately notifies the buyer/participant of whether the credit or debit card company has either approved or declined the authorization.

If the charge is authorized, at this point, the buyer/participant and the sponsor/seller become bound by the conditional terms and conditions. The buyer/participant is bound to pay the purchase price/payment amount with respect to the Listing and the seller/sponsor is bound to cause the project to be produced upon the satisfaction of the pre-defined criteria; and, if applicable, make content related to the production or development activities available to buyers; and, if applicable, produce and deliver a related product to buyers.

Also, upon confirmation of the credit or debit card authorization, the host database is updated by the system to reflect the transaction. The account page 24 for the buyer/participant and the account page 24 for the seller/sponsor are updated to reflect the transaction.

Through the additional linked-Listing feature of the present invention, sellers/sponsors have the ability to list two or more conditional Listings simultaneously while having to only sell investments associated with those Listings that achieve the desired threshold of demand as reflected in the pre-defined criteria. This linked-Listing feature allows sellers/sponsors to have buyer/participants demand dictate which of the linked Listings move forward. For example, a linked-listing could offer investments for two projects: project 1 could be a concert by a band in New York on November 4, project 2 could be a concert by the same band in Boston, also on November 4 with the one best satisfying the seller's pre-defined criteria being the one staged; or a linked-Listing for investments for the production of a new film could conditionally offer the same film with two or more different possible staring actors, with the Listing best satisfying the seller's pre-defined criteria being the one produced. As another example, a seller might set its pre-defined criteria as “most sales income as of Jul. 1, 2005”, and the seller (or the entity that is the subject of the investment) would only be obligated to produce the project that had generated the most sales income as of Jul. 1, 2005. The linked Listing feature can be used as both a promotional tool and an effective tool to aid sellers of investments in deciding which project to pursue.

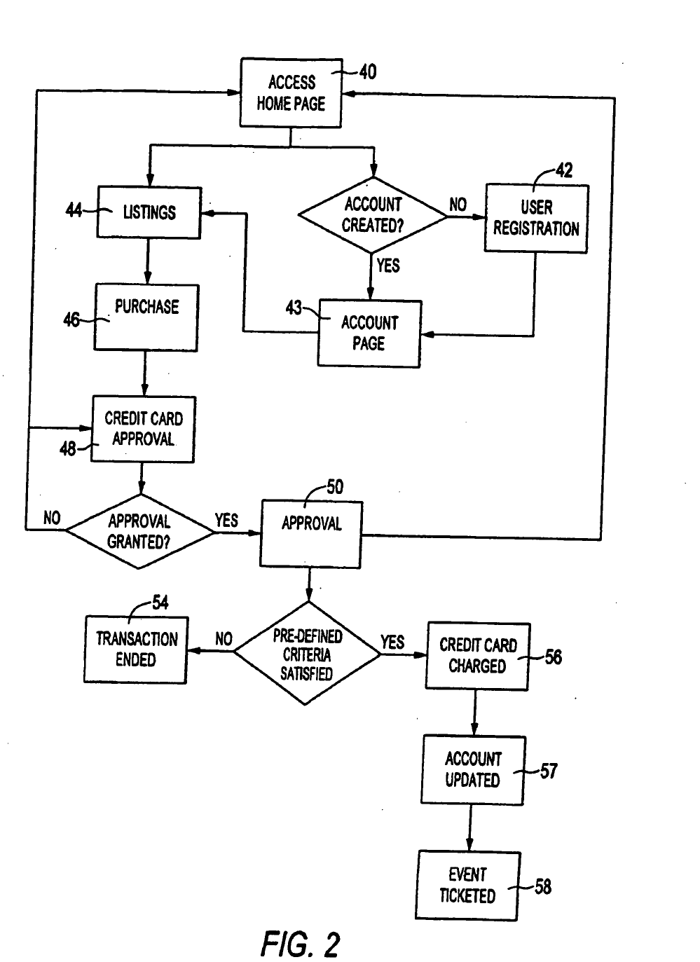

The process of the present invention from the perspective of the buyer/participant is shown in greater detail in FIG. 2. The first step is for the buyer/participant to access the home page 40 from a remote terminal and enter the public area of the website. The home page includes a search field that buyers/participants may use to search the Listings 44 according to criteria specified by the buyer/participant. The home page also includes a log-in field for buyers/participants to access their individual account page 43. If the buyer/participant has an account already set up with the website, the buyer/participant may log-in to their account page 43 by entering their account identification and password. If the buyer/participant does not have an account, the buyer/participant may register with the website by entering information and creating a new account 42. Once an account is established, the buyer/participant may then access its personal account page 43 where status of satisfaction information, account information and information relating to Listings purchased and monitored are displayed. The account page also includes a search field that buyers/participants may use to search the listings 44.

Alternatively, if the buyer/participant does not have an account or the buyer/participant elects not to access their account page, the buyer/participant may begin viewing information regarding the Listings directly by linking to the event listings 44 from the home page either through a search or a selection of a category.

If the buyer/participant is interested in a Listing, the buyer/participant will link to that Listing's page for further information relating to the Listing, including information explaining the seller's/sponsor's pre-defined criteria including the pre-defined time period set for the Listing. If the buyer/participant then wishes to make a purchase with respect to the Listing, the buyer/participant will select the purchase/payment option on the page and will be prompted to log-in prior to entering the purchase/payment page. If the buyer/participant does not have an account, the buyer/participant may register with the website and create an account, before being forwarded to the purchase/payment page.

Once on the purchase/payment page, the buyer/participant will select the details relating to their purchase/payment order. In cases where a Listing corresponds to an investment associated with a concert or sporting event where the buyer will also receive tickets to the event, such details may include the seating choices, and preferred delivery methods relating to the event related to project 46. In a case where a Listing corresponds to an investment associated with a specific film, a specific album, or other video or audio product, such details may include the type of media delivery or product, for example the specific film delivered on DVD or via download or by corresponding movie theater ticket or the specific album delivered on CD or via download, and other choices, if applicable. The buyer/participant then may proceed to the credit or debit card submission page to obtain credit or debit card approval 48. The buyer/participant then submits its credit or debit card and corresponding information. Once the buyer's or participant's credit or debit card information has been entered, the credit or debit card is processed for authorization approval via a communication link with the buyer's or participant's credit or debit card company. The credit or debit card company will either approve or decline the credit or debit card authorization. If the credit or debit card authorization is declined, the buyer/participant is returned to the credit or debit card submission page. The buyer/participant may then review the information just submitted to determine if there was an error or may try another credit or debit card. Otherwise, the buyer/participant may return to the home page 40 or exit the website.

If the credit or debit card authorization is approved, the buyer/participant is notified that the authorization was successful 50. The buyer/participant may then return to the home page 40 and begin the process all over for another Listing if desired or the buyer/participant may return to their account page 43 or exit the website.

After each authorized transaction, the system will update the database with respect to the applicable Listing. For example, if the pre-defined criteria relates to a total number of sales then the number of sales just completed shall increase the current count for the total sales number. If the pre-defined criteria relates to a total sales income amount, the total sales income amount will be increased by the revenue from the sales completed. After each authorized transaction the status of satisfaction information available to buyers, participants, sponsors and sellers will be updated as specified in the terms and conditions of that Listing.

At the expiration of the pre-defined time period, the system will check to determine whether the pre-defined criteria have been satisfied. If the pre-defined criteria are not fulfilled upon the expiration of the pre-defined time period, then the buyer's or participant's credit or debit card is not charged and the transaction is ended 54. Also, the seller or sponsor is not obligated to produce anything with respect to the Listing.

If the pre-defined criteria are fulfilled at any time prior to the expiration of the pre-defined time period, then, at such time, the buyer's/participant's credit or debit card account is charged 56. The buyer's/participant's account page is then updated to reflect the completion of the transaction 57. In the case of some Listings, the buyer/participant may be issued an e-ticket, ticket by mail, receipt or other purchase confirmation 58. The seller/sponsor is then obligated to produce the project associated with the investment; and, if applicable, make content related to the production or development activities available to buyers; and, if applicable, produce and deliver a related product to buyers.

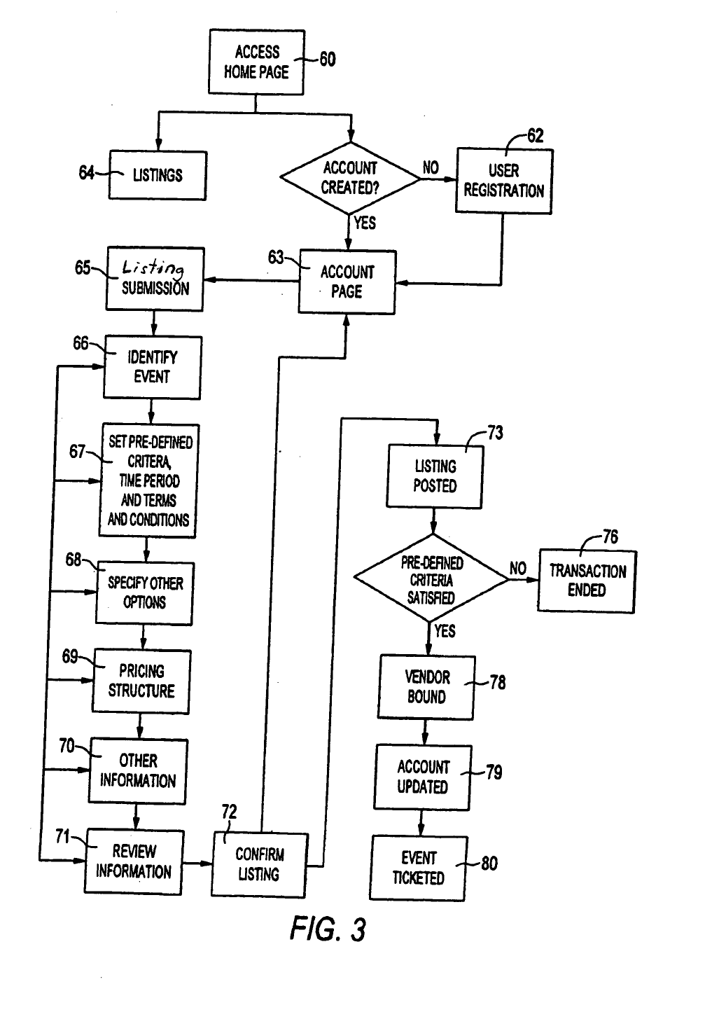

The process of the present invention from the perspective of the vendor/seller is shown in greater detail in FIG. 3. The seller/sponsor may access the website from a remote terminal similar to the buyer/participant and enter the website at the home page 60. The home page includes a log-in field for sellers/sponsors to access their account page 63. If the seller/sponsor has already established an account with the website, the seller/sponsor may log-in to their account page 63. If the seller/sponsor is a new user or has otherwise not yet established an individual account, the seller/sponsor may register with the website by entering information and creating a new account 62. Once an account is established the seller/sponsor may then access their private account page 63. On its account page, the seller/sponsor may view status of satisfaction information relating to any Listings associated with the seller/sponsor and other information relating to their account. From the home page, the seller/sponsor may also access the Listings on the website and view Listings provided by other sellers/sponsors.

If the seller/sponsor desires to provide a new Listing, the seller/sponsor will enter the new Listing submission page 65 from their account page 63. In order for the seller/sponsor to submit information for a new Listing, the seller/sponsor must be a registered user of the website. In order to submit a new Listing, the seller/sponsor must identify the type of Listing such as whether the Listing is for an investment corresponding to developing, providing or gaining a financial interest in a specified good, service, event, achievement or venture, or the like 66. The seller/sponsor then selects the pre-defined criteria applicable to the Listing, including a pre-defined time period during which transactions will be accepted, and further sets the terms and conditions applicable to the conditional sale/purchase commitment 67. If applicable, the seller identifies any content that will be made available to buyers upon the satisfaction of the pre-defined criteria 67. If applicable, the vendor identifies any product that will be produced and delivered to buyers upon the satisfaction of the pre-defined criteria 67. The seller/sponsor then selects other criteria options applicable to the Listing such as the linked feature, as applicable 68. The seller/sponsor then selects any pricing structure for the Listing such as the various pricing tiers and possible discounts to early buyers or other such pricing related options 69. Finally, the seller/sponsor provides information relating to the Listing such as the date, time, and location, and other relevant information, as applicable 70. After the seller/sponsor enters all of the listing information, the seller/sponsor has the opportunity to review the listing information and confirm its accuracy 71. If there are any corrections that should be made, the seller/sponsor may return to any of the new Listing submission steps to make any revisions that are necessary. If all of the information submitted is accurate, the seller/sponsor confirms the Listing 72. At this point, the Listing is submitted to the website and the seller/sponsor may return to their account page 63 if desired. The Listing will be posted on the website together with any other Listings from such seller/sponsor or any listings from any other sellers/sponsors at the date and time selected by the seller/sponsor.

Once the Listing is posted, the system will begin accepting conditional sale/payment transactions from buyers 73.

At the expiration of the pre-defined time period, the system will check to determine whether the pre-defined criteria have been satisfied. If the pre-defined criteria are not fulfilled by the pre-defined time period, the seller/sponsor is not obligated to issue the investments, or produce or perform anything with respect to the Listing and the transaction is ended 76. If the pre-defined criteria are satisfied at any time prior to the expiration of the pre-defined time period, then, at such time, all of the pre-authorized buyers/participants with respect to the Listing are charged, and at that moment the seller/sponsor becomes obligated to perform 78. The account pages of the buyers/participants and the seller/sponsor are then updated to reflect the satisfaction of the pre-defined criteria 79. Finally, in some embodiments, the buyer is issued an e-ticket, ticket by mail, receipt or other purchase confirmation 80, as applicable, and the seller/sponsor produces, performs and/or makes available an event, product, service and/or unique content associated with the Listing.

In an alternative embodiment of the present invention, the seller/sponsor has an option to make the Listing binding and accept all conditional purchases/payments made by buyers/participants even if the pre-defined criteria are not satisfied. For this option to be available to the seller/sponsor, a detailed explanation of such option must be included in the Listing terms and conditions that are reviewed and agreed to by the buyer/participant for that particular Listing. In exercising such option, the seller/sponsor may accept the current level of conditional sales/payment commitments and bind itself to perform in accordance with the terms of the Listing and charge the buyers/participants at that point. For a seller/sponsor, this is more efficient than re-submitting a Listing with criteria that are at lower levels.

For purposes of illustration, several examples of the present invention are set forth below:

### EXAMPLE 1

### Conditional Sale of Investment Items

In one embodiment, the website is used to raise capital for projects through the conditional sale of investment items online, wherein the investment items are investments in the form of financial instruments, such as securities or other cash instruments, or derivative instruments, that give the owner the rights to a financial interest in the success of a specified good, service, event, achievement or venture via a financial interest in an entity or company that (i) produces, develops, provides or has a financial interest in said good, service, event, achievement, or venture; or (ii) commits to produce, develop, provide or gain a financial interest in said good, service, event, achievement, or venture. In this embodiment, the pre-defined criteria are received from a seller of the investments, and must be satisfied before the seller is obligated to issue the investments or produce the project. The pre-defined criteria include an aggregate threshold volume of conditional purchases that must be made by a plurality of different buyers.

In this embodiment, commercial terms relating to making a conditional purchase of an investment item are displayed to the buyers over the website. The seller of the investments r agrees to produce the project in exchange for the conditional purchase of investment items.

For example, a seller of investments may wish to raise $500,000 to produce a specific new film: The seller (or the film production company that would be the subject of the investments) conditionally offers to produce the film and provide buyers with a financial interest in the film production company set up to produce and own the film, if the $500,000 can be raised by Jan. 1, 2007 through conditional sales of investment items.

In another example, a seller of investments may wish to raise $50,000 to produce a specific new music album: The seller (or the entity that would be the subject of the investments) conditionally offers to produce the album and provide buyers with a financial interest in an entity set up to receive profits from the album, if the $50,000 can be raised by Jan. 1, 2007.

In yet another example, a seller of investments may wish to raise $350,000 to produce a specific new video game: The seller (or the new company that would be the subject of the investments) conditionally offers to produce the video game and provide buyers with a financial interest in the new company formed to produce and own the video game, if the $350,000 can be raised by Jan. 1, 2007.

In yet another example, a seller of investments may wish to raise $10,000 to produce a specific new freelance journalistic work on refugees in Sudan: The seller (or the entity that would be the subject of the investments) conditionally offers to produce the journalistic work on refugees in Sudan and provide buyers with a financial interest in the entity formed to receive the profits from the vendors' journalistic work for the next 3 years to buyers if the $10,000 can be raised by Jul. 15, 2007 through conditional sales of investment items.

In yet another example, a seller of investments may wish to raise $5,000,000 to start a new film production company: The seller of the investments (or the new film production company) conditionally offers to produce at least 2 films and provide buyers with a financial interest in the film production company if the $5,000,000 can be raised by Jan. 1, 2007 through conditional sales of investment items.

In yet another example, a seller of investments may wish to raise $2,000,000 to start a new start-up technology company: The seller of the investments (or the new start-up technology company) conditionally offers to provide buyers with a financial interest in the company if the $2,000,000 can be raised by Feb. 1, 2007 through conditional sales of investment items.

In yet another example, a seller of investments may wish to raise $10,000,000 to start a new financial fund: The seller of the investments (or the new financial fund) conditionally offers to provide buyers with a financial interest in the fund if the $10,000,000 can be raised by Feb. 1, 2007 through conditional sales of investment items.

In yet other examples, a seller of investments may use this embodiment of the system to raise money to create or fund an entity to produce or develop: (i) a specific new comic book; (ii) a new book; (iii) a new documentary film; (iv) a new concert event; (v) a new music video; (vi) a new version of a film, such as a digitally re-mastered version; (vii) a new multi-episode series.

### EXAMPLE 2

### Conditional Sale of Investment Items & Content

In one embodiment, the website is used to raise capital for projects through the a conditional sale of investment items online, where, following satisfaction of the pre-defined criteria, and during the production or development activities, content is made available to each buyer that made one of the conditional purchase requests. The content conveys information related to production or development activities for a project. In this embodiment, the pre-defined criteria are received from a seller of investment items and must be satisfied before the seller is obligated to cause the project and the content to be produced. The pre-defined criteria include an aggregate threshold volume of conditional purchases that must be made by a plurality of different buyers.

In this embodiment, commercial terms relating to making a conditional purchase of an investment item are displayed to the buyers over the website. The content is also identified to the buyers over the website. The seller (or an entity that is the subject of the investments) agrees to make the content available to each buyer in exchange for the conditional purchase of investments during a time period following satisfaction of the pre-defined criteria and during the production or development activities (which commence, e.g., after satisfaction of the pre-defined criteria.)

The production or development activities may concern production or development of an artistic work, and in such cases, the content may corresponds to efforts of a creator of the artistic work to produce the artistic work. Alternatively, the production or development activities may concern production or development of a non-fiction work, and in such cases, the content may correspond to efforts of a creator of the non-fiction work to produce the non-fiction work. In other embodiments, the production or development activities may concern production or development of an interactive video game, and in such cases, the content may correspond to efforts of a creator of the video game to produce the video game. In still further embodiments, the production or development activities may concern production or development of a comic book, and in such cases, the content may correspond to efforts of a creator of the comic book to produce the comic book. In still further embodiments, the production or development activities may concern production or development of a new start up company, and in such cases, the content may correspond to “behind-the-scenes” footage of the company's operations. In still further embodiments, the production or development activities may concern production or development of a new record label, and in such cases, the content may correspond to “behind-the-scenes” footage of the record labels' artists on tour and/or producing albums and/or shooting music videos.

For example, a seller of investments may wish to raise $500,000 to start or support a film production company that will produce a specific new film: The seller (or the film production company) conditionally offers to produce the film, provide buyers with a financial interest in the film production company set up to produce and own the film, and provide ongoing “behind-the-scenes” content relating to the production or development activities of the film to buyers if the $500,000 can be raised by Jan. 1, 2007 through conditional sales of investment items.

In another example, a seller of investments may wish to raise $50,000 to start or support an entity that will produce a specific new music album: The seller (or the entity that will produce the new album) conditionally offers to produce the album, provide buyers with a financial interest in an entity that will receive profits from the album, and provide ongoing “behind-the-scenes” content relating to the production or development activities of the album to buyers if the $50,000 can be raised by Jan. 1, 2007 through conditional sales of investment items.

In yet another example, a seller of investments may wish to raise $350,000 to start or support a new company produce a specific new video game: The seller (or the new company that will produce the new video game) conditionally offers to produce the video game, provide buyers with a financial interest in the new company formed to produce and own the video game, and provide ongoing “behind-the-scenes” content relating to the production or development activities of the video game to buyers if the $350,000 can be raised by Jan. 1, 2007 through conditional sales of investment items.

In yet another example, a seller of investments may wish to raise $10,000 to start or support an entity to produce a specific new freelance journalistic work on refugees in Sudan: The seller of the investments (or the entity that will produce the work) conditionally offers to produce the journalistic work on refugees in Sudan, provide buyers with a financial interest in an entity formed to receive the profits from the vendors' journalistic work for the next 3 years, and provide content relating to the production or development activities of the journalistic work to buyers if the $10,000 can be raised by Jul. 15, 2007 through conditional sales of investment items.

In yet another example, a seller of investments may wish to raise $5,000,000 to start a new film production company: The seller (or the new film production company) conditionally offers to produce at least 2 films, provide buyers with a financial interest in the film production company, and provide content relating to the production or development activities of the films produced by the company to buyers if the $5,000,000 can be raised by Jan. 1, 2007 through conditional sales of investment items.

In yet another example, a seller of investments may wish to raise $2,000,000 to start a new technology company: The seller of the investments (or the new technology company) conditionally offers to provide buyers with a financial interest in the company, and provide ongoing content relating to the production or development activities of the company to buyers if the $2,000,000 can be raised by Feb. 1, 2007 through conditional sales of investment items.

In yet another example, a seller of investments may wish to raise $10,000,000 to start a new financial fund: The seller (or the new financial fund) conditionally offers to provide buyers with a financial interest in the fund, and provide ongoing content relating to the production or development (management) of the fund to buyers if the $10,000,000 can be raised by Feb. 1, 2007 through conditional sales of investment items.

In yet other examples, a seller of investments may use this embodiment of the system to raise money to create or fund an entity to produce or develop: (i) a specific new comic book; (ii) a new book; (iii) a new documentary film; (iv) a new concert event; (v) a new music video; (vi) a new version of a film, such as a digitally re-mastered version; (vii) a new multi-episode series.

### EXAMPLE 3

### Conditional Sale of Investment Items & A Product

In one embodiment, the website is used to raise capital for projects through the conditional sale of investment items online, where, following satisfaction of the pre-defined criteria, a product related to a project associated with the investment is produced and delivered to each buyer that made one of the conditional purchase requests. In this embodiment, the pre-defined criteria are received from a seller of investment items and must be satisfied before the seller (or an entity that is the subject of the investments) is obligated to cause the project to be produced and the product to be produced and delivered. The pre-defined criteria include an aggregate threshold volume of conditional purchases that must be made by a plurality of different buyers.

In this embodiment, commercial terms relating to making a conditional purchase of an investment item are displayed to the buyers over the website. The product is also identified to the buyers over the website. The seller of the investments (or an entity that is the subject of the investments) agrees to produce and deliver the product available to each buyer in exchange for the conditional purchase.

The project may concern the production or development of a product, and in such cases, the product produced and delivered to buyers may be the same product or copy of that product. For example when the project concerns the production or development of an artistic work the product may be a media copy of the work (DVD, CD, downloadable file, or a delivery via on Demand service or other forms of digital or analog delivery).

The project may concern the production or development of an event, and in such cases, the product produced and delivered to buyers may be a ticket to the event.

In other cases, the product may be an item related to the project, such as a t-shirt, hat, or other product related to the project.

In many cases, the prices of investment items for sale are correlated with particular products that will be produced and delivered to the buyer.

For example, a seller of investments may wish to raise $500,000 to produce a start or fund a film production company to produce a specific new film: The seller of the investments (or the film production company) conditionally offers to produce the film, provide buyers with a financial interest in the film production company set up to produce and own the film, and provide DVDs of the specific film to buyers who purchased $25 investment items and downloads of the specific film to buyers who purchased $10 investment items if the $500,000 can be raised by Jan. 1, 2007 through conditional sales of investment items.

In another example, a seller of investments may wish to raise $50,000 to produce a specific new music album: The seller of the investments (or an entity that is the subject of the investments) conditionally offers to produce the album, provide buyers with a financial interest in an entity set up to receive profits from the album, and provide CDs of the specific album to buyers who purchased $15 investment items and downloads of the specific album to buyers who purchased $8 investment items if the $50,000 can be raised by Jan. 1, 2007 through conditional sales of investment items.

In yet another example, a seller of investments may wish to raise $350,000 to start or fund a new company to produce a specific new video game: The seller of the investments (or the new company) conditionally offers to produce the video game, provide buyers with a financial interest in the new company formed to produce and own the video game, and provide DVDs of the video game to buyers if the $350,000 can be raised by Jan. 1, 2007 through conditional sales of investment items.

In yet another example, a seller of investments may wish to raise $5,000,000 to start or fund a new film production company: The seller (or the new film production company) conditionally offers produce at least 2 films, provide buyers with a financial interest in the film production company, and provide DVDs of all the movies the production company makes in the first 5 years to buyers if the $5,000,000 can be raised by Jan. 1, 2007 through conditional sales of investment items.

In yet another example, a seller of investments may wish to raise $3,500,000 to start or fund a new company to produce a specific new cell phone: The seller of the investments (or the new company) conditionally offers to produce the cell phone, provide buyers with a financial interest in the new company formed to produce and own the cell phone, and provide the cell phone to buyers if the $3,500,000 can be raised by Jan. 1, 2007 through conditional sales of investment items.

In yet another example, a seller of investments may wish to raise $20,000,000 to start or fund a new company produce a specific new car: The seller of the investments (or the new company) conditionally offers to produce the car, provide buyers with a financial interest in the new company formed to produce and own the car, and provide the car to buyers who purchased $50,000+($50,000 or higher) investment items if $20,000,000 can be raised by Jan. 1, 2007 through conditional sales of investment items.

For yet another example, a seller of investments may wish to raise $50,000 to start or fund a new company to produce a specific new music album: The seller of the investments (or the new company) conditionally offers to produce the album, provide buyers with a financial interest in the new company formed to produce and own the album, and provide buyers with a t-shirt corresponding to the specific album if the $50,000 can be raised by Jan. 1, 2007 through conditional sales of investment items.

In yet another example, a seller of investments may wish to raise $80,000 to start or fund an entity to produce a specific new concert event: The seller of the investments (or the entity that will produce the new concert event) conditionally offers to produce the concert event, provide buyers with a financial interest in an entity set up to receive profits from the concert event, and provide box-seat tickets to buyers who purchased $20 investment items and balcony-seat tickets to buyers who purchased $10 investment items if the $80,000 can be raised by Jan. 1, 2007 through conditional sales of investment items.

In yet other examples, a seller of investments may use this embodiment of the system to raise money to start or fund entities to produce or develop: (i) a specific new comic book; (ii) a new book; (iii) a new documentary film; (iv) a new version of a film, such as a digitally re-mastered version; (v) a new multi-episode series; (vi) a new start-up company; (vii) a new financial fund.

### EXAMPLE 4

### Conditional Sale of Investment Items, Content & A Product

In one embodiment, the website is used to raise capital for investments associated with projects through the conditional sale of investment items online, where, following satisfaction of the pre-defined criteria, a product related to the project is produced and delivered to each buyer that made one of the conditional purchase requests; and where during the production or development activities, content is made available to each buyer that made one of the conditional purchase requests. In this embodiment, the pre-defined criteria are received from a seller of investment items and must be satisfied before the seller of the investments (or an entity that is the subject of the investments) is obligated to cause the project and the content to be produced and the product to be produced and delivered. The pre-defined criteria include an aggregate threshold volume of conditional purchases that must be made by a plurality of different buyers.

In this embodiment, commercial terms relating to making a conditional purchase of an investment item are displayed to the buyers over the website. The content is also identified to the buyers over the website. The seller of the investments (or an entity that is the subject of the investments) agrees to: (i) produce and deliver the product to each buyer in exchange for the conditional purchase, and (ii) make the content available to each buyer in exchange for the conditional purchase during a time period following satisfaction of the pre-defined criteria and during the production or development activities (which commence, e.g., after satisfaction of the pre-defined criteria.)

For example, a seller of investments may wish to raise $500,000 to start or fund a film production company to produce a specific new film: The seller of the investments (or the film production company) conditionally offers to produce the film, provide buyers with a financial interest in the film production company set up to produce and own the film, provide ongoing “behind-the-scenes” content relating to the production or development activities of the film to buyers, and provide DVDs of the specific film to buyers who purchased $25 investment items and downloads of the specific film to buyers who purchased $10 investment items if the $500,000 can be raised by Jan. 1, 2007 through conditional sales of investment items.

In yet another example, a seller of investments may wish to raise $5,000,000 to start a new record company. The seller of the investments (or the new record company) conditionally offers produce at least 8 albums, provide buyers with a financial interest in the new record company, provide ongoing content relating to the production or development activities of the albums to buyers, and provide CDs of all the albums the record label makes in the first 2 years to buyers if the $5,000,000 can be raised by Jan. 1, 2007 through conditional sales of investment items.

For yet another example, a seller of investments may wish to raise $50,000 to start or fund a new company to produce a specific new music album: The seller of the investments (or the new company) conditionally offers to produce the album, provide buyers with a financial interest in the new company formed to produce and own the album, provide ongoing “behind-the-scenes” content relating to the production or development activities of the album to buyers, and provide buyers with a t-shirt corresponding to the specific album if the $50,000 can be raised by Jan. 1, 2007 through conditional sales of investment items.

In yet another example, a seller of investments may wish to raise $80,000 to start or fund an entity to produce a specific new concert event: The seller of the investments conditionally offers to produce the concert event, provide buyers with a financial interest in an entity set up to receive profits from the concert event, provide ongoing “behind-the-scenes” content relating to the production or development activities of the concert event to buyers, and provide box-seat tickets to buyers who purchased $20 investment items and balcony-seat tickets to buyers who purchased $10 investment items if the $80,000 can be raised by Jan. 1, 2007 through conditional sales of investment items.

Although certain embodiments of the present invention have been described in the foregoing Detailed Description and have been illustrated in the accompanying Figures, it will be understood that the invention is not limited to the embodiments disclosed but is capable of numerous modifications without departing from the scope of the invention claimed. Also, although the methods disclosed herein have been described and shown with reference to particular steps performed in a particular order, it will be understood that these steps may be combined, sub-divided or re-ordered to form an equivalent method without departing from the teachings of the present invention. It will be further understood by those skilled in the art that the conditional sales items described above (as well as those described in parent application Ser. Nos. 11/501,427 and 10/946,521) may be aggregated in different combinations, which are considered within the scope of the present invention. For example, a seller of investments may sponsor a single Listing to raise $500,000 to fund a film where: for $25 buyers receive a DVD and behind-the-scenes content, for $15 receive only get a DVD, for $5 buyers receive a downloaded copy, and for $500 buyers receive an investment item that gives them 1% of the profits and behind-the-scenes content. Accordingly, unless specifically indicated herein, the order and grouping of the steps is not a limitation of the present invention.

What is claimed is:

1. A method for raising capital through the conditional sale of investments online, wherein each investment provides an owner with a financial interest in an entity that (i) produces, develops, provides or has a financial interest in a specified good, service, event, achievement or venture; or (ii) commits to produce, develop, provide or gain a financial interest in the good, service, event, achievement, or venture, the method comprising:
providing a network site accessible over a communication network from remote computers;
receiving, from a seller of the investments, pre-defined criteria that must be satisfied before the seller or entity is obligated to produce or develop the good, service, event, achievement or venture, wherein the pre-defined criteria includes an aggregate threshold volume of conditional purchases that must be made by a plurality of different buyers for the investments;
displaying commercial terms relating to making a conditional purchase of at least one of the investments, to the buyers over the network site, wherein the commercial terms include one or more seller-defined prices associated with the conditional purchase;
receiving conditional purchase requests for at least one of the investments, from the plurality of buyers over the network site, each of said conditional purchase requests including credit or debit account information from a buyer and specifying a conditional purchase amount that includes at least one of the seller-defined prices, and in response to each conditional purchase request, executing an authorize-only credit or debit transaction using credit or debit account information from the buyer, wherein the authorize-only credit or debit transaction conditionally binds the buyer to make a purchase associated with at least one of the investments only upon the satisfaction of the pre-defined criteria; and
upon the satisfaction of the pre-defined criteria, automatically charging a credit or debit account of each buyer that made one of said conditional purchase requests, and obligating the seller or entity to produce or develop the good, service, event, achievement or venture; and
wherein the conditional purchase amounts specified in the conditional purchase requests include seller-defined prices that are independent of an aggregate volume of conditional purchases made by the buyers.

2. The method of claim 1, wherein upon satisfaction of the pre-defined criteria, the entity is obligated to make content available to each buyer in exchange for the conditional purchase during a time period following satisfaction of the pre-defined criteria, wherein the content conveys information related to production or development activities for the good, service, event, achievement, or venture.

3. The method of claim 1, wherein upon satisfaction of the pre-defined criteria, the entity is further obligated to provide a product to each buyer in exchange for the conditional purchase during a time period following satisfaction of the pre-defined criteria, wherein the product relates to the good, service, event, achievement, or venture.

4. The method of claim 1, further comprising defining, by the seller, a period for a buyer to conditionally purchase at least one of the investments over the network site.

5. The method of claim 1 wherein, after the credit or debit account of a buyer is charged, the buyer is issued a receipt confirming the purchase of at least one of the investments.

6. The method of claim 1 wherein the seller offers to conditionally sell a plurality of investments, each content item having its own pre-defined criteria, the seller becoming bound to issue only those investments that achieve the pre-defined criteria.

7. The method of claim 1 further comprising providing for a secure area of the network site, the secure area including a private account page accessible by a seller that has created an account with the network site.

8. The method of claim 7 wherein the seller may view, within the secure area, information updated to reflect the completion of a transaction.

9. The method of claim 7 wherein the seller may view the status of the progress toward satisfaction of the pre-defined criteria on the vendor's private account page.

10. The method of claim 7 wherein the seller may create a listing of information for new investments on a new page accessible by the seller from the seller's private account page.

11. The method of claim 1, wherein a secure area of the network site is accessed for entering credit or debit account information in order to make a conditional purchase request, the method further comprising transmitting the credit or debit account information to a credit or debit account company over the network.

12. The method of claim 11 further comprising accessing the secure area of the website, the secure area permitting the buyer to create an account page.

13. The method of claim 12 wherein the completion of a purchase transaction is confirmed on the buyer's account page.

14. The method of claim 12 wherein the buyer may view the status of the progress toward satisfaction of the pre-defined criteria for an investment of interest on the buyer's account page, but only to the extent permitted by the seller.

15. The method of claim 2, wherein the buyer receives the content online through an area of the network site associated with the content on the network site or through a cable, satellite, or other digital network.

16. The method of claim 2, wherein the production or development activities concern production or development of a product comprising an artistic work, and the content corresponds to efforts of a creator of the artistic work to produce the artistic work.

17. The method of claim 2, wherein the production or development activities concern production or development of a product comprising a non-fiction work, and the content corresponds to efforts of a creator of the non-fiction work to produce the non-fiction work.

18. The method of claim 2, wherein the production or development activities concern production or development of a product comprising an interactive video game, and the content corresponds to efforts of a creator of the video game to produce the video game.

19. The method of claim 2, wherein the production or development activities concern production or development of a product comprising a comic book, and the content corresponds to efforts of a creator of the comic book to produce the comic book.

20. A system for raising capital through the conditional sale of investments online, wherein each investment provides an owner with a financial interest in an entity that (i) produces, develops, provides or has a financial interest in a specified good, service, event, achievement or venture; or (ii) commits to produce, develop, provide or gain a financial interest in the good, service, event, achievement, or venture, the system comprising:
a network site accessible over a communication network from remote computers;
means for receiving, from a seller of the investments, pre-defined criteria that must be satisfied before the seller or entity is obligated to produce or develop the good, service, event, achievement or venture; wherein the pre-defined criteria is an aggregate threshold volume of conditional purchases that must be made by a plurality of different buyers for the investments;
means for displaying commercial terms relating to making a conditional purchase for at least one of the investments, event, product or service, to the buyers over the network site, wherein the commercial terms include one or more seller-defined prices associated with the conditional purchase;
means for receiving conditional purchase requests for at least one of the investments, from the plurality of buyers over the network site, each of said conditional purchase requests including credit or debit account information from a buyer and specifying a conditional purchase amount that includes at least one of the seller-defined prices;
means, responsive to each conditional purchase request, for executing an authorize-only credit or debit transaction using credit or debit account information from the buyer, wherein the authorize-only credit or debit transaction conditionally binds the buyer to make a purchase associated with at least one of the investments only upon the satisfaction of the pre-defined criteria; and
means, responsive to the satisfaction of the pre-defined criteria, for automatically charging a credit or debit account of each buyer that made one of said conditional purchase requests and obligating the seller or entity to produce or develop the good, service, event, achievement or venture; and
wherein the conditional purchase amounts specified in the conditional purchase requests include seller-defined prices that are independent of an aggregate volume of conditional purchases made by the buyers.

21. The system of claim 20, further comprising, means for defining, by the seller, a period for a buyer to make a purchase of at least one of the investments over the network site.

22. The system of claim 20, wherein upon satisfaction of the pre-defined criteria, the entity is obligated to make content available to each buyer in exchange for the conditional purchase during a time period following satisfaction of the pre-defined criteria, wherein the content conveys information related to production or development activities for the good, service, event, achievement, or venture, and, further comprising means for issuing a ticket for the event to a buyer after the credit or debit account of the buyer is charged.

23. The system of claim 20 further comprising means for issuing a receipt confirmation for at least one of the investments to a buyer after the credit or debit account of the buyer is charged.

24. The system of claim 20 further comprising means for monitoring the satisfaction of the pre-defined criteria and displaying information relating to the pre-defined criteria over a private account page.

25. The system of claim 22, wherein the production or development activities concern production or development of a product comprising an artistic work, and the content corresponds to efforts of a creator of the artistic work to produce the artistic work.

26. The system of claim 22, wherein the production or development activities concern production or development of a product comprising a non-fiction work, and the content corresponds to efforts of a creator of the non-fiction work to produce the non-fiction work.

27. The system of claim 22, wherein the production or development activities concern production or development of a product comprising an interactive video game, and the content corresponds to efforts of a creator of the video game to produce the video game.

28. The system of claim 22, wherein the production or development activities concern production or development of a product comprising a comic book, and the content corresponds to efforts of a creator of the comic book to produce the comic book.

29. The system of claim 20, wherein upon satisfaction of the pre-defined criteria, the entity is further obligated to provide a product, other than the investment, to each buyer in exchange for the conditional purchase during a time period following satisfaction of the pre-defined criteria, wherein the product relates to the good, service, event, achievement, or venture.

30. A computer useable medium and computer readable code embodied on the computer useable medium for raising capital through the conditional sale of investments online, wherein each investment provides an owner with a financial interest in an entity that (i) produces, develops, provides or has a financial interest in a specified good, service, event, achievement or venture; or (ii) commits to produce, develop, provide or gain a financial interest in the good, service, event, achievement, or venture, the computer readable code comprising code which, when executed by a processor, performs the following steps:
providing a network site accessible over a communication network from remote computers;
receiving, from a seller of the investments, pre-defined criteria that must be satisfied before the seller or entity is obligated to produce or develop the good, service, event, achievement or venture, wherein the pre-defined criteria is an aggregate threshold volume of conditional purchases that must be made by a plurality of different buyers for at least one of the investments;
displaying commercial terms relating to making a conditional purchase for at least one of the investments to the buyers over the network site, wherein the commercial terms include one or more seller-defined prices associated with the conditional purchase;
receiving conditional purchase requests for at least one of the investments from the plurality of buyers over the network site, each of said conditional purchase requests including credit or debit account information from a buyer and specifying a conditional purchase amount that includes at least one of the seller-defined prices, and in response to each conditional purchase request, executing an authorize-only credit or debit transaction using credit or debit account information from the buyer, wherein the authorize-only credit or debit transaction conditionally binds the buyer to make a purchase associated with the at least one of the investments only upon the satisfaction of the pre-defined criteria; and
upon the satisfaction of the pre-defined criteria, automatically charging a credit or debit account of each buyer that made one of said conditional purchase requests and obligating the seller or entity to produce or develop the good, service, event, achievement or venture; and
wherein the conditional purchase amounts specified in the conditional purchase requests include seller-defined prices that are independent of an aggregate volume of conditional purchases made by the buyers.

31. The computer useable medium and computer readable code of claim 30 wherein a buyer has a seller-defined period to purchase at least one of the investments over the network site.

32. The computer useable medium and computer readable code of claim 30 further comprising computer useable medium and computer readable code for monitoring the satisfaction of the pre-defined criteria.

33. A method for raising capital through the conditional sale of investments online, wherein each investment provides an owner with a financial interest in an entity that (i) produces, develops, provides or has a financial interest in a specified good, service, event, achievement or venture; or (ii) commits to produce, develop, provide or gain a financial interest in the good, service, event, achievement, or venture, the method comprising:
providing a network site accessible over a communication network from remote computers;
receiving, from a seller of the investments, pre-defined criteria that must be satisfied before the seller or entity is obligated to produce or develop the good, service, event, achievement or venture, wherein the pre-defined criteria is an aggregate threshold volume of conditional purchases that must be made by a plurality of different buyers for at least one of the investments; the seller or entity having an option to agree to cause the good, service, event, achievement or venture to be developed or produced even though the pre-defined criteria have not been satisfied;
displaying commercial terms relating to making a conditional purchase for at least the investments to the buyers over the network site, wherein the commercial terms include one or more seller-defined prices associated with the conditional purchase;
receiving conditional purchase requests for at least one of the investments from the plurality of buyers over the network site, each of said conditional purchase requests including credit or debit account information from a buyer and specifying a conditional purchase amount that includes at least one of the seller-defined prices, and in response to each conditional purchase request, executing an authorize-only credit or debit transaction using credit or debit account information from the buyer, wherein the authorize-only credit or debit transaction conditionally binds the buyer to make a purchase associated with at least one of the investments only upon the satisfaction of the pre-defined criteria or upon the seller or entity exercising the option; and
upon the vendor exercising the option, automatically charging a credit or debit account of each buyer that made one of said conditional purchase requests and obligating the seller or entity to produce or develop the good, service, event, achievement or venture; and
wherein the conditional purchase amounts specified in the conditional purchase requests include seller-defined prices that are independent of an aggregate volume of conditional purchases made by the buyers.

34. A method for raising capital through the conditional sale of investments online, wherein each investment provides an owner with a financial interest in an entity that (i) produces, develops, provides or has a financial interest in a specified good, service, event, achievement or venture; or (ii) commits to produce, develop, provide or gain a financial interest in the good, service, event, achievement, or venture, the method comprising:
providing a network site accessible over a communication network from remote computers;
receiving, from a seller of investments, a plurality of linked goods, services, events, achievements or ventures and, pre-defined criteria that must be satisfied before the seller or entity is obligated to cause a subset of the plurality of linked goods, services, events, achievements or ventures to be produced, wherein the pre-defined criteria specify buyer demand parameters that determine which, if any, of the subset of the plurality of linked goods, services, events, achievements or ventures that the seller or entity is obligated to cause to be produced; wherein the subset includes less than all of the plurality of linked goods, services, events, achievements or ventures;
displaying commercial terms relating to making a conditional purchase for one of the investments to the buyers over the network site;
receiving conditional purchase requests for each of the investments from the plurality of buyers over the network site, each of said conditional purchase requests being associated with one of the linked goods, services, events, achievements or ventures, each of said conditional purchase requests including credit or debit account information from a buyer and specifying a conditional purchase amount, and in response to each conditional purchase request, executing an authorize-only credit or debit transaction using credit or debit account information from the buyer, wherein the authorize-only credit or debit transaction conditionally binds the buyer to make a purchase for one of the investments only upon the satisfaction of the pre-defined criteria for the linked goods, services, events, achievements or ventures associated with the conditional purchase of the buyer; and
upon the satisfaction of the pre-defined criteria associated with each linked good, service, event, achievement and/or venture in the subset, automatically charging a credit or debit account of each buyer that made one of said conditional purchase requests associated with each linked good, service, event, achievement or venture in the subset, and obligating the seller or entity to cause each linked good, service, event, achievement or venture in the subset to be produced.
